(19) United States
(12) Patent Application Publication
(10) Pub. No.: US 2025/0363971 A1
(43) Pub. Date: Nov. 27, 2025

(54) Enhanced Electric Guitar Offering Variables for Seven Pickups

(71) Applicant: Anthony Bonacci, Sebastian, FL (US)

(72) Inventor: Anthony Bonacci, Sebastian, FL (US)

(21) Appl. No.: 18/670,926

(22) Filed: May 22, 2024

(51) Int. Cl. G10H 1/34; G10D 1/08; G10D 3/04; G10D 3/06

(52) U.S. Cl. CPC G10H 1/342; G10D 1/085; G10D 3/04; G10D 3/06

(57) ABSTRACT

The present invention relates to a modified electric guitar capable of offering multiple variables to pickup selections and wider ranges of tones. The guitar can be, for example, a Stratocaster™ styled guitar including a face and a fingerboard. The guitar further can include three double coil humbucker pickups including a bridge pickup, a middle pickup, and a neck pickup. A push-pull button (i.e. actuator) can be positioned to act or function to actuate the bridge pickup allowing the bridge pickup to function simultaneously with the other two pickups, and therefore enable a user to have all three pickups on at the same time. The middle and neck pickups can also be used as single coil pickups to provide more options of generating music. The guitar includes seven-way pickups and switch options with double tone controls to actuate various pickups thereby enabling diverse tones.

### FIELD OF THE INVENTION

The present invention relates generally to guitars. More specifically, the present invention relates to a novel electric guitar device for providing multiple variables to pickup selections on an electric guitar. The device comprises a standard electric guitar including, for example, a Stratocaster™ style body equipped with three double coil humbucker pickups. The guitar can also have seven-way switch options with double tone controls, and a push-pull that activates the bridge pickup. This will enable the user to have all three pickups on at the same time. This also features split coil switches for the neck and middle pickups that either allow single coil or humbucker pickup selections. The guitar offers a way to create more diverse tones and music. Accordingly, the present disclosure makes specific reference thereto. Nonetheless, it is to be appreciated that aspects of the present invention are also equally applicable to other like applications, devices, and methods of manufacture.

### BACKGROUND

By way of background, electrical stringed instruments such as electric guitars are quite commonly used by musicians around the world. Electric guitars are one of the most important instruments in popular music and are quite popular among musicians and among listeners to musicians. Although conventional electric guitars are part of the public music craze, it can be difficult to reach different tones and variances on a guitar, and individuals may only be able to obtain standard 5-way or 3-way pickup selector options. The 5-way or 3-way pickup selector options that allow for five or three combinations of pickups in conventional guitars enables only limited range of tones and music.

Additionally, in situations where a user desires to hit higher and lower tones on a conventional guitar, it can be nearly impossible for the users. Individuals may be unable to explore wider ranges of tones on a single guitar with pickup selector options of conventional electric guitars heretofore known.

Further, with the standard electric guitars, minimal developments have been done to improve the quality of music produced using guitars, and there may be a lot of noisy interference picked up by coil pickups that can be quite audible, sounding like a constant hum or buzz in the music. Individuals may be unable to fully enjoy their music and may desire to reduce the unwanted interference produced by coil pickups.

Furthermore, while using conventional electric guitars, individuals usually can select a single pickup at a particular time and may be unable to use multiple pickups at the same time. This limits the capability of users to produce diverse tones and music using standard electric guitars.

Therefore, there exists a long-felt need in the art for a modified electric guitar that enables the users to produce diverse tones and music. There is also a long-felt need in the art for a modified electric guitar that enables the users to reach different tones and variances in a convenient manner. Additionally, there is a long-felt need in the art for a modified electric guitar that provides improvement over 5-way pickup options that is generally featured in conventional electric guitars. Moreover, there is a long-felt need in the art for a modified electric guitar that enables the users to hit higher and lower tones easily. Further, there is a long-felt need in the art for a modified electric guitar that enables individuals to play music with minimal noisy and unwanted interference. Furthermore, there is a long-felt need in the art for a modified electric guitar that enhances the quality of music produced using guitars and ensures the users fully enjoy the music played on guitars. Finally, there is a long-felt need in the art for a modified electric guitar that enables the users to select multiple pickups at the same time and further enables the users to produce diverse tones and music.

The subject matter disclosed and claimed herein, in one embodiment thereof, comprises an electric guitar. The electric guitar can be designed to have, for example, a Stratocaster™ style body for offering multiple variables for pickup selections and wider ranges of tones, thus allowing a user to make different and more unique types of music. The guitar features a face and fingerboard having strings, a bridge double coil humbucker pickup, a middle double coil humbucker pickup, and a neck double coil humbucker pickup, a seven-way pickup mechanism with tone controls, a push-pull button for activating (i.e. actuating) the bridge pickup, and a separate split coil switch for each of the neck and middle pickups allowing the pickups to function as one of single coil or humbucker pickup selections.

In this manner, the novel modified electric guitar of the present invention accomplishes all of the forgoing objectives and provides a relatively easy and convenient solution to play diverse tones and more unique types of music. The modified electric guitar of the present invention is also user friendly, as it ensures minimal noisy and unwanted interference in music played using guitars and enables the users to enjoy the music completely. Additionally, the users can easily choose to have all the three pickups on at the same time to produce wider ranges of music.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an electric guitar. The electric guitar further comprising a bridge double coil humbucker pickup, a middle double coil humbucker pickup, and a neck double coil humbucker pickup, a seven-way switch with double tone controls for producing at least seven tone combinations, a push-pull button for activating (i.e. actuating) the bridge pickup, and a separate split coil switch for each of the neck and middle pickups allowing the pickups to function as one of single coil or humbucker pickup selections.

In yet another embodiment, the electric guitar is, for example, a Fender™ Stratocaster™ type guitar having a fingerboard and a face.

In yet another embodiment, the tone controls are master potentiometers.

In yet another embodiment, the seven-way switch is wired to the bridge pickup, the middle pickup, and the neck pickup allowing use of all the three pickups simultaneously.

In yet another embodiment, the pickups function as a single coil pickup using a toggle button.

In yet another embodiment, a humbucker pickup splits to turn on one of the Slug mode or Screw mode.

In yet another embodiment, a system for providing seven-way pickups in an electric guitar is disclosed. The system is embedded in the electric guitar and includes three double coil humbucker pickups including a bridge pickup, a middle pickup, and a neck pickup; a push-pull for activating (i.e. actuating) bridge pickup, an independent coil switch button for each of the middle pickup and the neck pickup for splitting said pickups to single coil pickups, a switch button with tone controls for providing one or more pickups selected from the group consisting of: bridge pickup alone, bridge and middle pickup in parallel, middle pickup alone, middle and neck pickup in parallel, neck pickup alone, bridge and neck pickup in parallel, and all three pickups in parallel.

In yet another embodiment, a method for providing seven-way pickups in an electric guitar is described. The method includes the steps of providing an electric guitar having a push-pull that activates/actuates the humbucker bridge pickup, double tone controls for allowing connections with the neck and middle pickup; pushing the push-pull in the UP position to act or function as the bridge pickup with one or both of the other middle pickup and neck pickup allowing a user to use all three pickups simultaneously.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an enhanced electric guitar of the present invention in accordance with the disclosed architecture;

FIG. 2 illustrates a circuit diagram showing splitting of a humbucker used in the electric guitar of the present invention for being used as a single coil pickup in accordance with the disclosed architecture;

FIG. 3 illustrates an internal view of an exemplary double coil humbucker pickup used in the electric guitar of the present invention in accordance with the disclosed architecture; and

FIG. 4 illustrates an exemplary connection diagram showing use of push-pull to act or function as a bridge pickup for using all three pickups simultaneously in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a modified electric guitar that enables the users to produce diverse tones and music. There is also a long-felt need in the art for a modified electric guitar that enables the users to reach different tones and variances in a convenient manner. Additionally, there is a long-felt need in the art for a modified electric guitar that provides improvement over 5-way pickup options that are generally featured in conventional electric guitars. Moreover, there is a long-felt need in the art for a modified electric guitar that enables the users to hit higher and lower tones easily. Further, there is a long-felt need in the art for a modified electric guitar that enables individuals to play music with minimal noisy and unwanted interference. Furthermore, there is a long-felt need in the art for a modified electric guitar that enhances the quality of music produced using guitars and ensures the users fully enjoy the music played on guitars. Finally, there is a long-felt need in the art for a modified electric guitar that enables the users to select multiple pickups at the same time and further enables the users to produce diverse tones and music.

The present invention, in one exemplary embodiment, is a novel system for providing seven-way pickups in an electric guitar. The system features three double coil humbucker pickups including a bridge pickup, a middle pickup and a neck pickup; a push-pull for activating (i.e. actuating) bridge pickup such that the bridge pickup may be used with one or both of the middle pickup and the neck pickup, an independent coil switch button for each of the middle pickup and the neck pickup for splitting said pickups to single coil pickups, the system providing one or more pickups selected from the group consisting of: bridge pickup alone, bridge and middle pickup in parallel, middle pickup alone, middle and neck pickup in parallel, neck pickup alone, bridge and neck pickup in parallel, and all three pickups in parallel.

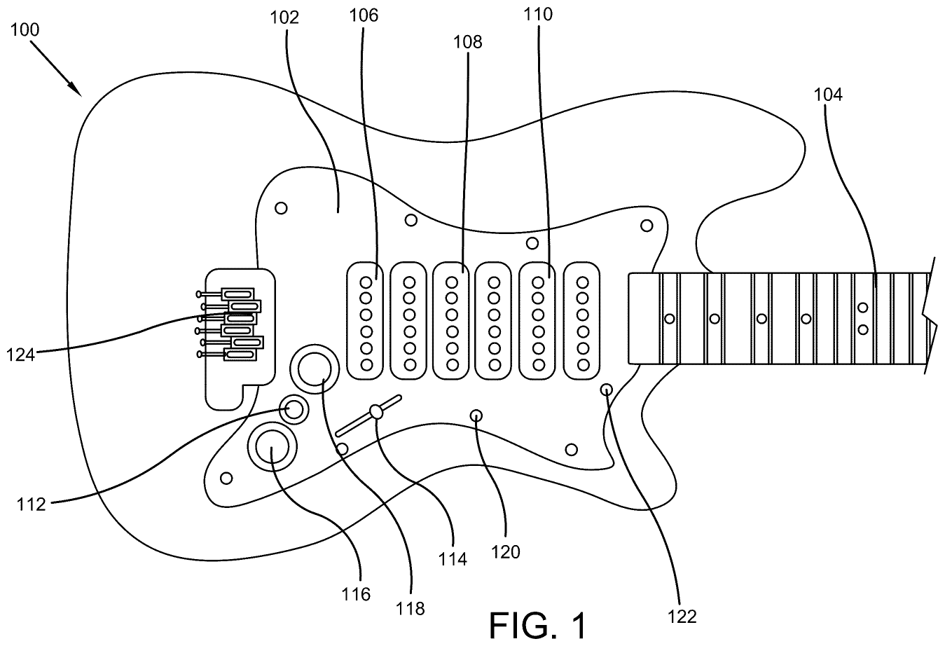

Referring initially to the drawings, FIG. 1 illustrates a perspective view of one potential embodiment of the enhanced electric guitar 100 of the present invention in accordance with the disclosed architecture. As shown in FIG. 1, one embodiment of the electric guitar 100 of the present invention, for example, can be a Fender™ Stratocaster™ type guitar having a face 102 and a fingerboard 104. The guitar 100 has three double coil humbucker pickups 106,108, 110 positioned in a spaced-apart arrangement. The bottom double coil humbucker pickup 106 is positioned near the bridge 124 and is referred to as bridge pickup. The top double coil humbucker pickup 110 is positioned near the fingerboard 104 and is referred to as neck pickup. The double coil humbucker pickup 108 positioned between the bridge pickup 106 and the neck pickup 110 is referred to as middle pickup. The double coil humbucker pickups allow the guitar 100 to produce louder and clearer sounds relative to conventional single-coil pickups.

The pickups 106,108, 110 reside under the strings of the guitar 100 which are not shown for the simplified explanation supra. Each of the dual coil humbucker pickups contain two coils that are wired out of phase with each other. The wiring causes the hum generated by each coil to be cancelled out by the other coil. More specifically, the guitar 100 has a push-pull button 112 for activating (i.e. actuating) the bridge pickup 106. The push-pull button 112 is configured to allow use of all three pickups 106,108, 110 together (i.e. simultaneously) for a better tone and sound.

The guitar 100 has a seven-way switch 114 as opposed to a conventional five-way switch found in Stratocaster™ guitars. The seven-way switch 114 with double tone controls 116,118 offers a way to make different and more unique types of music. The seven-way switch 114 also enables use of all three pickups in parallel. Table 1 provides an exemplary pickup combination provided by the seven-way switch that also maintains the combinations provided by the conventional five-way switch.

TABLE 1

| Position | Pickup combinations |
|---|---|
| Position 1 | Bridge pickup alone |
| Position 2 | Bridge + middle pickup in parallel |
| Position 3 | Middle pickup alone |
| Position 4 | Middle + neck pickup in parallel |
| Position 5 | Neck pickup alone |
| Position 6 | Bridge + neck in parallel |
| Position 7 | All three pickups in parallel |

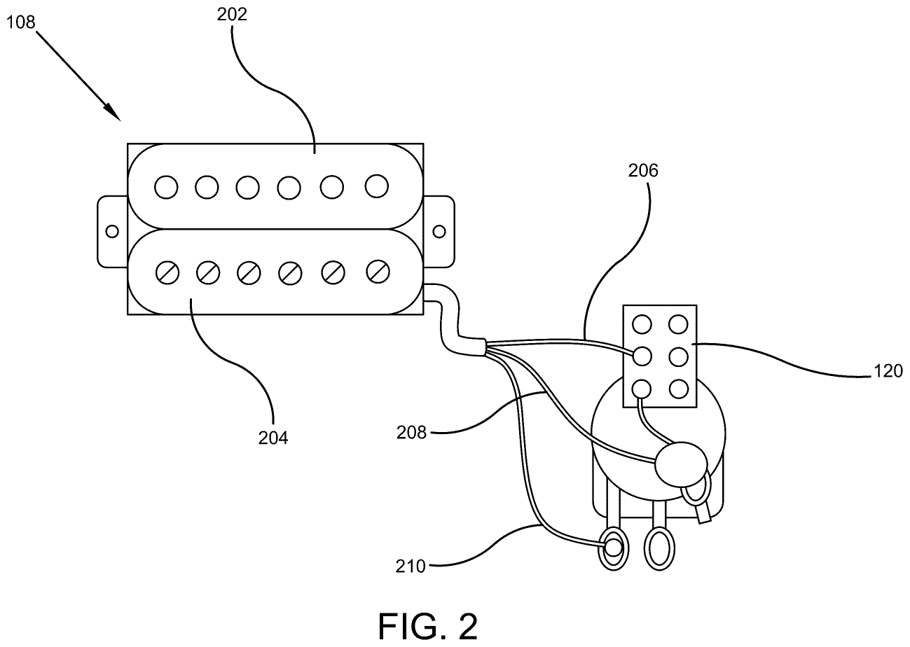

The guitar 100 has a first split coil switch 120 for splitting the middle pickup 108 to act or function as a single coil pickup. Similarly, a second split coil switch 122 is positioned for splitting the neck pickup 110 to act or function as a single coil pickup. Details of the splitting of the humbucker pickups is described in FIG. 2.

FIG. 2 illustrates a circuit diagram showing splitting of a humbucker used in the electric guitar 100 of the present invention for being used as a single coil pickup in accordance with the disclosed architecture. As stated earlier, a humbucker pickup contains two coils, and a split coil switch can “shut off” one of the coils, causing the humbucker to sound and act like a single coil pickup. Preferably, each of the split coil switches 120,122 is a mini-toggle switch and is positioned into the face of the guitar 100. As illustrated, the exemplary humbucker pickup 108 is split to act or function to actuate a slug end 202 and disable a screw end 204. When the switch 120 is in an UP position, the humbucker 108 is in a single coil mode; and, when the switch 120 is in a DOWN position, the humbucker 108 is in a full humbucker mode. More precisely, the red and white wires 206 from the humbucker 108 are connected to the switch 120 to allow the coil split. The green and bare wires 208 are grounded, and the black wire 210 is used as the hot output from the pickup.

It should be appreciated that any other way of splitting the humbuckers 108,110 can be used in the electric guitar 100 of the present invention. Further, the screw end 204 can alternatively be turned on in the split mode while shutting the slug end 202.

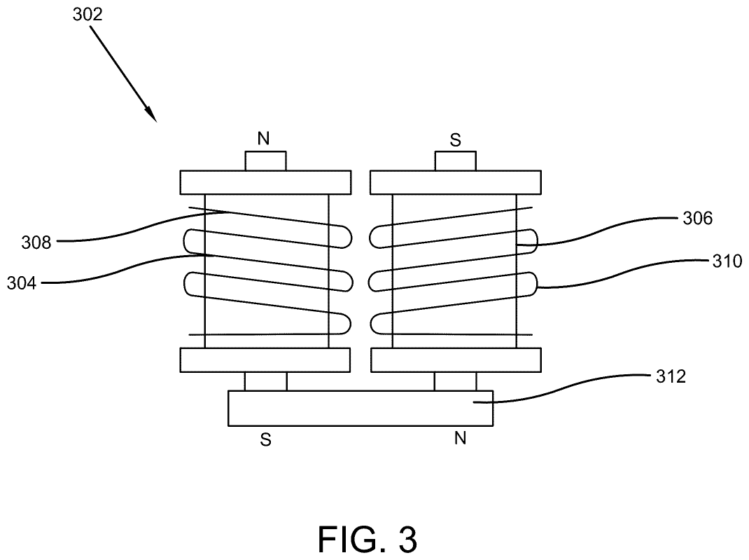

FIG. 3 illustrates an internal view of an exemplary double coil humbucker pickup used in the electric guitar 100 of the present invention in accordance with the disclosed architecture. As illustrated, the humbucker 302 is an exemplary humbucker and represents any of the humbuckers used in the guitar 100. More specifically, the humbucker 302 consists of two paired single coil pickups 304,306 having the coils 308,310, respectively. The coils 308,310 are magnetically and electrically reversed to each other, thereby flowing the current in opposite directions inside the two coils and a magnet 312. The magnet 312 can be placed under the coils 308,310, and can be oriented so as to oppositely polarize the coils 308,310. Accordingly, the noise captured by the coils 308,310 are being offset by 180° to produce a calibrated high sound.

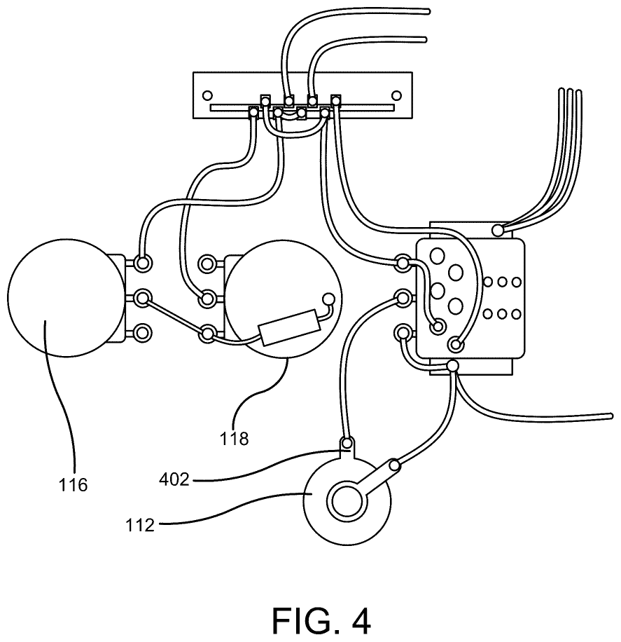

FIG. 4 illustrates an exemplary connection diagram showing use of push-pull to act or function as to actuate the bridge pickup for using all three pickups simultaneously in accordance with the disclosed architecture. Addition of the push-pull 112 effectively changes the guitar in order to enable seven-way pickups. The push-pull 112 when in UP position (position 402) activates the bridge pickup and using the tone controls 116,118 activates the neck and middle pickups either in humbucker or single coil mode as described in FIG. 2. Accordingly, a user can use all of the three pickups simultaneously for providing unique music sound.

It should be noted that the push-pull and other components are grounded for activating (i.e. actuating) the bridge pickup.

The invention also discloses a method for providing seven-way pickups in an electric guitar. The method includes the steps of providing an electric guitar that includes a system for providing all three pickups simultaneously. The guitar has a push-pull that activates the humbucker bridge pickup, while the double tone enables connections with the neck and middle pickup. When push-pull is in the UP position, the bridge pickup is activated and can be used with one or both of the activated middle pickup and neck pickup allowing a user to use all three pickups simultaneously and create great music.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “enhanced electric guitar”, “electric guitar”, “guitar”, and “multiple variables providing electric guitar”, are interchangeable and refer to the enhanced electric guitar for providing multiple pickup selections 100 of the present invention.

Notwithstanding the foregoing, the enhanced electric guitar for providing multiple pickup selections 100 of the present invention can be of any suitable size and configuration as is known in the art without affecting the overall concept of the invention, provided that it accomplishes the above-stated objectives. One of ordinary skill in the art will appreciate that the enhanced electric guitar for providing multiple pickup selections 100 as shown in the FIGS. are for illustrative purposes only, and that many other sizes and shapes of the enhanced electric guitar for providing multiple pickup selections 100 are well within the scope of the present disclosure. Although the dimensions of the enhanced electric guitar for providing multiple pickup selections 100 are important design parameters for user convenience, the enhanced electric guitar for providing multiple pickup selections 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electric guitar comprising:
a face;
a bridge;
a neck;
a fingerboard;
a bridge double coil humbucker pickup positioned proximal to said bridge;
a neck double coil humbucker pickup positioned proximal to said fingerboard;
a middle double coil humbucker pickup positioned between said bridge pickup and said neck pickup, wherein each of said bridge pickup, said neck pickup, and said middle pickup include two coils wired out of phase with each other;
a push-pull button for actuating said bridge pickup selectively along with one or both of said middle pickup and said neck pickup; and
a six-way switch including double tone controls, wherein said six-way switch includes at least six positions selected from the group consisting of: said bridge pickup alone; said bridge pickup and said middle pickup in parallel; said middle pickup alone; said middle pickup and said neck pickup in parallel; said neck pickup alone; and said bridge pickup and said neck pickup in parallel for enabling six-way pickups.

2. The electric guitar of claim 1 further comprising a seven-way switch wherein said seven-way switch includes at least a seventh position including all said bridge pickup, said middle pickup, and said neck pickup in parallel.

3. The electric guitar of claim 1, further comprising a first independent split coil switch button for said middle pickup to function as a first single coil pickup.

4. The electric guitar of claim 3, wherein said first independent split coil switch button is a toggle switch.

5. The electric guitar of claim 3 further comprising a second independent split coil switch button for said neck pickup to function as a second single coil pickup.

6. The electric guitar of claim 5, wherein said second independent split coil switch button is a toggle switch.

7. The electric guitar of claim 1, wherein said push-pull button for actuating simultaneously said bridge pickup, said middle pickup, and said neck pickup.

8. An electric guitar comprising:
a face;
a bridge;
a neck;
a fingerboard;
a bridge double coil humbucker pickup positioned proximal to said bridge;
a neck double coil humbucker pickup positioned proximal to said fingerboard;
a middle double coil humbucker pickup positioned between said bridge pickup and said neck pickup, wherein each of said bridge pickup, said neck pickup, and said middle pickup include two coils wired out of phase with each other;
a push-pull button for actuating said bridge pickup selectively along with one or both of said middle pickup and said neck pickup; and
a seven-way switch including double tone controls, wherein said seven-way switch includes at least seven positions selected from the group consisting of: said bridge pickup alone; said bridge pickup and said middle pickup in parallel; said middle pickup alone; said middle pickup and said neck pickup in parallel; said neck pickup alone; said bridge pickup and said neck pickup in parallel; and all said bridge pickup, said middle pickup, and said neck pickup in parallel for enabling seven-way pickups.

9. The electric guitar of claim 8, further comprising a first independent split coil switch button for said middle pickup to function as a first single coil pickup and a second independent split coil switch button for said neck pickup to function as a second single coil pickup.

10. The electric guitar of claim 9, wherein said push-pull button for actuating simultaneously said bridge pickup, said middle pickup, and said neck pickup.

11. The electric guitar of claim 9, wherein said first independent split coil switch in a first position actuates a slug end of said middle pickup and disables a screw end of said middle pickup.

12. The electric guitar of claim 11, wherein said second independent split coil switch in a first position actuates a slug end of said neck pickup and disables a screw end of said neck pickup.

13. The electric guitar of claim 9, wherein said first independent split coil switch in a first position disables a slug end of said middle pickup and actuates a screw end of said middle pickup.

14. The electric guitar of claim 13, wherein said second independent split coil switch in a first position disables a slug end of said neck pickup and actuates a screw end of said neck pickup.

15. An electric guitar comprising:
a face;
a bridge;
a neck;
a fingerboard;
a bridge double coil humbucker pickup positioned proximal to said bridge;
a neck double coil humbucker pickup positioned proximal to said fingerboard;
a middle double coil humbucker pickup positioned between said bridge pickup and said neck pickup;
a seven-way switch including double tone controls, wherein said seven-way switch includes at least seven positions selected from the group consisting of: said bridge pickup alone; said bridge pickup and said middle pickup in parallel; said middle pickup alone; said middle pickup and said neck pickup in parallel; said neck pickup alone; said bridge pickup and said neck pickup in parallel; and all said bridge pickup, said middle pickup, and said neck pickup in parallel for enabling seven-way pickups;
wherein said bridge pickup includes a first single coil pickup and a first coil therearound, and a second single coil pickup and a second coil therearound;
wherein said first coil and said second coil are magnetically and electrically reversed to each other; and
a magnet adjacent to said first coil and said second coil to oppositely polarize said first coil and said second coil.

16. The electric guitar of claim 15 further comprising a push-pull button for actuating said bridge pickup selectively along with one or both of said middle pickup and said neck pickup.

17. The electric guitar of claim 16 further comprising a first tone control for actuating said neck pickup selectively in a humbucker mode or a single coil mode.

18. The electric guitar of claim 17 further comprising a second tone control for actuating said middle pickup selectively in a humbucker mode or a single coil mode.

19. The electric guitar of claim 18 further comprising a first independent split coil switch button for said middle pickup to function as a first single coil pickup and a second independent split coil switch button for said neck pickup to function as a second single coil pickup.

20. The electric guitar of claim 19, wherein said push-pull button for actuating simultaneously said bridge pickup, said middle pickup, and said neck pickup.
